(19) United States
(12) Patent Application Publication
(10) Pub. No.: US 2002/0024187 A1
(43) Pub. Date: Feb. 28, 2002

(54) Snowboard suspension system

(76) Inventor: Kaj Gyr, Portland, OR (US)

Correspondence Address: KOLISCH HARTWELL DICKINSON MCCORMACK & H, EUSER, 520 S.W. YAMHILL STREET, SUITE 200, PORTLAND, OR, 97204

(21) Appl. No.: 09/908,220

(22) Filed: Jul. 17, 2001

Related U.S. Application Data
(63) Continuation-in-part of application No. 09/239,892, filed on Jan. 29, 1999, now abandoned.
Application No. 09/239,892 is a continuation-in-part of application No. 09/105,974, filed on Jun. 26, 1998, now abandoned.
Application No. 09/105,974 is a continuation of application No. 08/538,754, filed on Oct. 2, 1995, now abandoned.

(51) Int. Cl. B62B 13/00

(52) U.S. Cl. 280/14.22; 280/14.21

(57) ABSTRACT

A snowboard suspension system which comprises a mounting plate (27) which is connected to a binding plate (29) via one or more hinges (26). One or more dampers (30) situated between the binding plate (29) and the mounting plate (27) serve to dampen any compressive forces. A connection plate (31) may be added to produce a compound system.

### CROSS-REFERENCE TO RELATED APPLICATION

This application is a continuation-in-part of U.S. patent application Ser. No. 09/239,892, filed Jan. 29, 1999 which is a continuation-in-part of U.S. patent application Ser. No. 09/105,974, filed Jun. 26, 1998, which application is a continuation of U.S. patent application Ser. No. 08/538,754, filed Oct. 2, 1995.

### FIELD OF THE INVENTION

This invention is related to shock absorbing devices for snowboards, specifically to such devices which mitigate uneven terrain, while enhancing the performance of the snowboard.

### BACKGROUND AND SUMMARY OF THE INVENTION

Snowboarding has evolved from a fledgling sport in the 70's to a huge recreational and commercial enterprise in the 90's. There: have been many recent advances in board and binding technology, but only one which specifically addressed the issue of shock absorption. This is simply a high-density foam pad which is mounted under the boarder's boot. Because this concept has been used in many other similar applications, it isn't patented. Quite frankly, it isn't effective either.

Although snowboarding is similar to snow skiing in many ways, there are some salient differences. Most notably, the boarder's legs are fixed in a transverse position on a single board, which precludes any independent movement of the legs. The boarder executes turns by angling the knees in concert with rotation and angling of the torso. As such, one can turn as quickly as on skiis, and, surprisingly, go just about as fast. Although the feel of charging down a slope is somewhat akin to surfing a large wave, one does not have the convenience of simply falling off the board should a fall be in the making. Instead, the attached board can become a veritable torsion bar on the body, which has resulted in a spate of injuries unique to snowboarder,.

One of the primary causes of falls and snowboard-specific injuries is bumps, and how the boarder negotiates them. Unlike in skiing, where the legs are independent, the boarder's legs are in a fixed position, which reduces their available “travel”, or ability to absorb the shock of a bump. Tearing of the collateral ligaments in the knee can result from pitching forward due to this decreased absorptive capacity. A prime example of the need for additional shock absorption is apparent when snowboarding in fresh snow over a hard sub-layer. In this situation, the whole body is constantly receiving unpredictable jolts. Thus, in the interest of preventing injuries, and adding a new dynamic to the “feel” of the board, I submit the following designs.

Since similar designs as those described for snowboards may be used for skiis and in-line skates, I have also covered these possibilities in this application. However, in the interest of simplicity, unless otherwise specified, all designs will be referred to as snowboard suspension systems.

Accordingly, several objects and advantages of the present invention are:

(a) to provide a simple means for absorbing shocks from bumpy terrain, while allowing for optimal edge control.

(b) to create an entirely new dynamic for the snowboarder—a more lively “feel”, and enhanced turning capability.

(c) to provide a means for the boarder to move forward on level terrain without undoing the bindings, by “bouncing” the board back and forth—similar to what skateboarders do.

(d) to minimize the possibility of injury from trough terrain—decrease the amount of wear and tear on the boarder's body.

(e) to increase the possibilities in “freestyle” boarding, due to the springier dynamic.

(f) to allow for a greater range of weight distribution and fore-aft transference of weight during a turn.

(g) to make the sport more appealing to older people, whose bodies aren't as resilient as they once were.

Still further objects and advantages will become apparent from a consideration of the ensuing description and drawings.

In summary, the invention is a snowboard suspension system for use with a snowboard that includes an elongate, flexible snow-planing member, dual elongate bindings for receiving a user's boots, and where the long axis of the bindings are located at an angle relative to the long axis of the snow-planing member. The snowboard suspension system of the invention includes dual suspension elements, each being coupled to a corresponding one of the dual bindings, and each suspension element having a top surface, a bottom surface and a desired thickness, and being formed to compress a preselected amount when a suitable force is applied to either the top or bottom surface. The invention also includes joining means for coupling each suspension element to the snow-planing member so that both suspension elements are linked by the snowboard.

The dual suspension elements may also each include a binding member with a long axis and securing means for attaching to a corresponding binding. The joining means may take the form of dual mounting members each with corresponding long axes and securing means for attaching to the snow-planing member so that the long axis of each mounting plate is at an angle relative to the long axis of the snow-planing member.

### BRIEF DESCRIPTION OF THE DRAWINGS

FIG. 1 is an isometric view of the preferred embodiment of the snowboard suspension system of the invention as it could be used by a snowboarder with a snowboard.

FIG. 2 is an enlarged, fragmentary front elevational view of the snowboard suspension system for the snowboarder's right boot depicted in FIG. 1, with the binding and right boot removed to focus attention on certain features of the invention.

FIG. 3 is an enlarged, fragmentary exploded view of the combination of the snowboard suspension system for the snowboarder's right boot depicted in FIG. 1, the snowboarder's right boot and associated binding, and the snowboard.

FIG. 4 is a greatly enlarged, exploded view of the snowboard suspension system for the snowboarder's right boot depicted in FIG. 3, with the binding and right boot removed to focus attention on certain features of the invention.

FIGS. 5-8 are each like FIG. 2, front elevational views of the snowboard suspension system for the snowboarder's right boot, except that the snowboard is removed to focus on certain other features of the invention.

FIG. 9 is a fragmentary isometric view depicting an alternate embodiment of the snowboard suspension system of the invention.

FIG. 10 is a fragmentary isometric view depicting an alternate embodiment of the snowboard suspension system of the invention.

FIGS. 11-12 are each fragmentary bottom views of a certain component of the invention shown in FIG. 4 to illustrate a way to provide attachment of the invention to the two standard types of conventional snowboards.

FIG. 13 is an enlarged, sectional view through line 12-12 of FIG. 3, and also showing an uncompressed and compressed position of the snowboard suspension system.

FIGS. 14-15 are like FIG. 1, each fragmentary, isometric views of the preferred embodiment of the snowboard suspension system of the invention as it could be used by a snowboarder with a snowboard, except that the snowboarder and bindings are not depicted to focus attention on certain features of the invention.

All of the Remaining Drawings are Side Views.

FIG. 16 shows a standard snowboard with bindings attached. The generic looking binding illustrated is meant to represent both “soft” and “plate” bindings. Most snowboarders mount the boot/binding obliquely to the board, not parallel to it.

FIG. 17 shows a simple spring-type snowboard suspension system with bottom stop.

FIG. 18 shows a hinge-type snowboard suspension system with damper.

FIG. 19 demonstrates how the various suspension systems are mounted on the board (hinge-type snowboard suspension system with baffles shown).

FIG. 20 shows a cant.

FIG. 21 shows a cant placed under a spring-type snowboard suspension system with bottom stop.

FIG. 22 shows a compound spring-type snowboard suspension system.

FIG. 23 shows a hinged compound snowboard suspension system with dampers.

FIG. 24 shows a scissor-type snowboard suspension system.

FIG. 25 shows a telescoping-type snowboard suspension system.

FIG. 26 shows a parallelogram-type snowboard suspension system with damper.

FIG. 27 shows a cantilevered full-length snowboard suspension system with damper.

FIG. 28 shows a hinge-type snowboard suspension system with damper adapted to fit a pair of in-line roller skates.

### Reference Numerals in FIGS. 16-28

321 baffle

322 snowboard

323 bottom stop

324 boot/binding

325 spring hinge

326 hinge

327 mounting plate

328 damper connector

329 binding plate

330 damper

331 connection plate

332 cant

333 scissor arms

334 telescoping damper

335 slanted arms

336 skate boot

337 wheels

### DETAILED DESCRIPTION OF THE PREFERRED EMBODIMENT

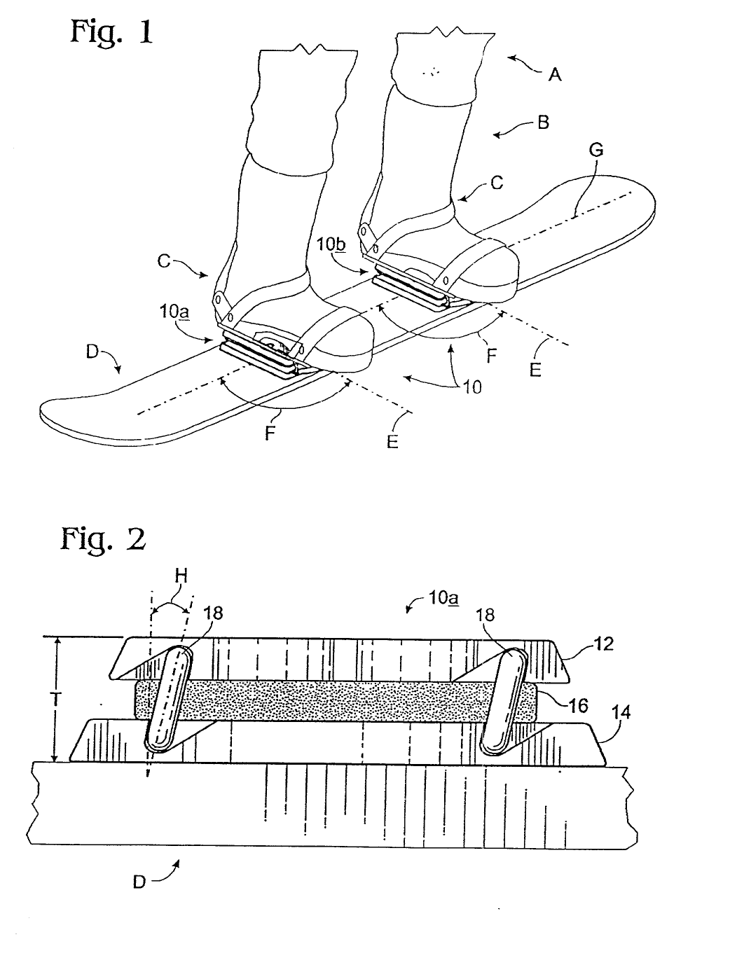

FIG. 1 shows an isometric of the preferred embodiment of the snowboard suspension system of the invention at 10. Also shown are portions of a snowboarder's legs and feet A, the snowboarder's boots B, associated boot bindings C, and a snowboard D. Any conventional boots, bindings and snowboards are usable with the invention. Snowboard D may be thought of as an elongate, flexible snow-planing member, and dual elongate bindings C are for receiving boots B. Corresponding long axes E of the bindings are located at angles F relative to a long axis G of the snowboard. System 10 includes fastener structure that preferably takes the form of dual suspension elements 10a and 10b, each being coupled to a corresponding one of the dual bindings C.

Referring to FIGS. 2-3, the illustration of suspension element 10a is meant to be representative of both elements 10a-10b, where each element includes a top region or plate 12, a bottom region or plate 14 and a desired thickness T (preferably between about 1- to 1.5-inches), and being formed to compress a preselected amount when a suitable force is applied to either the top or bottom plate. Also depicted is compressible section such as foam layer 16 and links such as bales 18. As shown in FIGS. 2-8, each bale is angled or canted so that it is not at 90 degrees with respect to a plane containing the snowboard. In FIG. 2, an angle H depicts of less than 90 degrees, and preferably in the range of about 70-80 degrees, provides the proper bias toward compression that allows system 10 to meet the above objectives. The dimensions of plate 12 may be about 9-inches in length by about 6-inches in width, and the dimensions of plate 14 may be about 9-inches in length and about 6.75-inches in width. These dimensions have been found suitable for conventional snowboards, but suitable changes in such dimensions are possible.

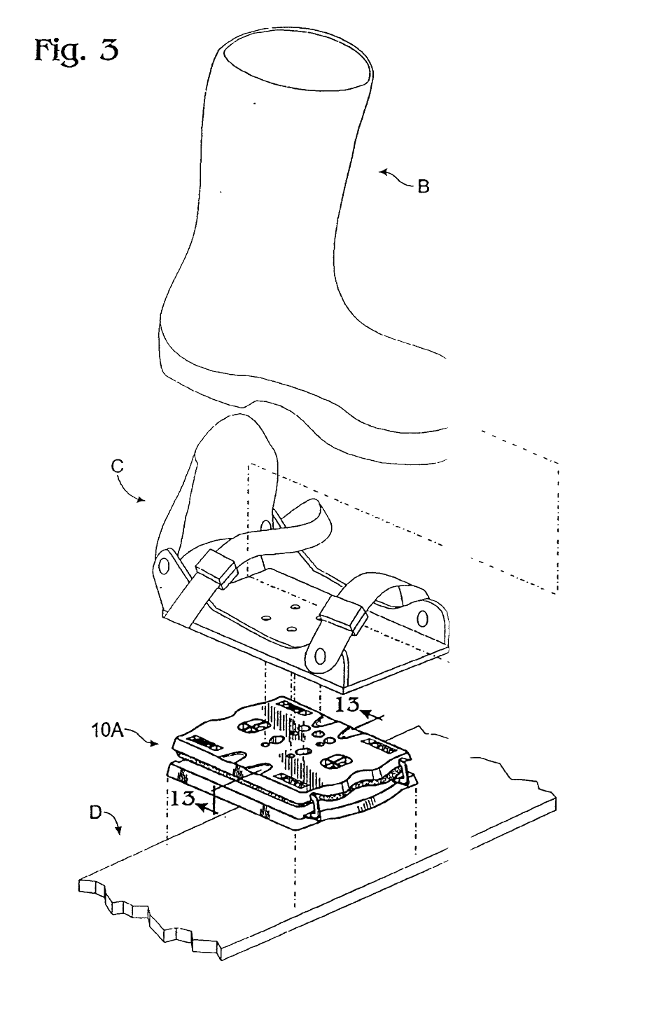

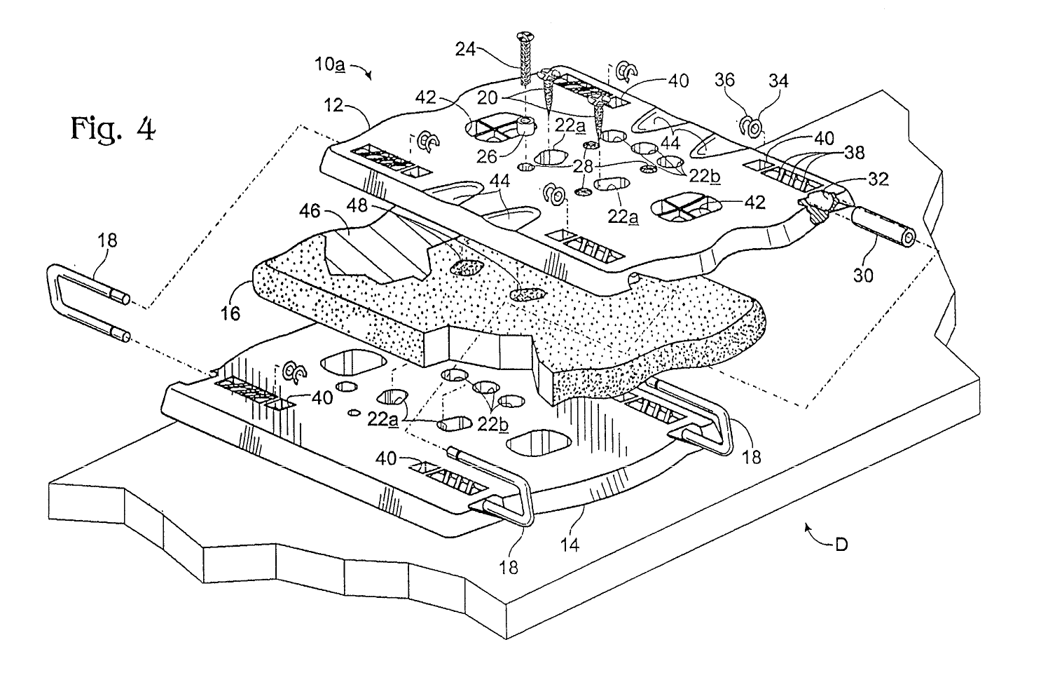

Referring to FIG. 4, suspension element 10a also includes first joining means or first joiners 20 for coupling each suspension element 10a (and 10b, although undepicted in FIG. 4) to snowboard D (as shown in FIG. 1) so that both suspension elements are linked by the snowboard. First joiners 20 may also be thought of as screws or screw-serts, and preferably take the form of 6 mm×16 mm stainless steel screws. For reasons that will be described, either 3- or 4-screws are placed through appropriately sized openings 22a (oblong-shaped in cross section), 22b (approximately circular in cross section) in plate 12 and in plate 14.

Referring to FIGS. 3-4, suspension element 10a also includes second joining means or second joiners 24 (again preferably screws—two representative ones of the four are depicted) for attaching to a corresponding binding C (see FIG. 3) by placing the lead ends of the screws through suitable openings in the bindings (see FIG. 3), and turning the screws into threaded fittings 26 (a representative one of which is shown in FIG. 4) that are suitably fastened within openings 28 formed in plate 12.

Still referring to FIGS. 3-4, the ends of each bale 18 are placed through corresponding cylindrical sleeves such as sleeve 30 in each plate 12, 14, with each sleeve suitably fastened within cylindrical bale openings, such as opening 32 formed in each plate 12, 14. The ends of each bale 18 are circumferentially notched to allow placement of a washer 34 and lock washer 36 to hold each bale in the desired position within each sleeve. If each plate is formed by molding a suitable composite material, it has been found that reinforcing the length of each cyclindrical opening that receives a sleeve like sleeve 30 with angled, linear sections 38 will tend to limit shrinkage and ensure proper location of bale openings in the finished plate. Recesses 40 are preferably square in cross section and allow access to the ends of the bales for placement/sliding movement of washers 34 and lock washers 36. Recesses 42 are the usual types of recesses when forming the plate from spheroidal elastomers. Recesses 44 are provide a distinctive look to plate 12 and are ornamental.

Referring again to FIG. 4, a suitable adhesive layer 46 is applied to the top surface of foam layer 16. It is possible to use any suitable means to attach foam layer 16 to one or both plates 12, 14. Suitable openings 48 are formed in foam layer 16 to allow screws and screwdrivers to pass therethrough to attach plate 14 to snowboard D (see FIG. 13).

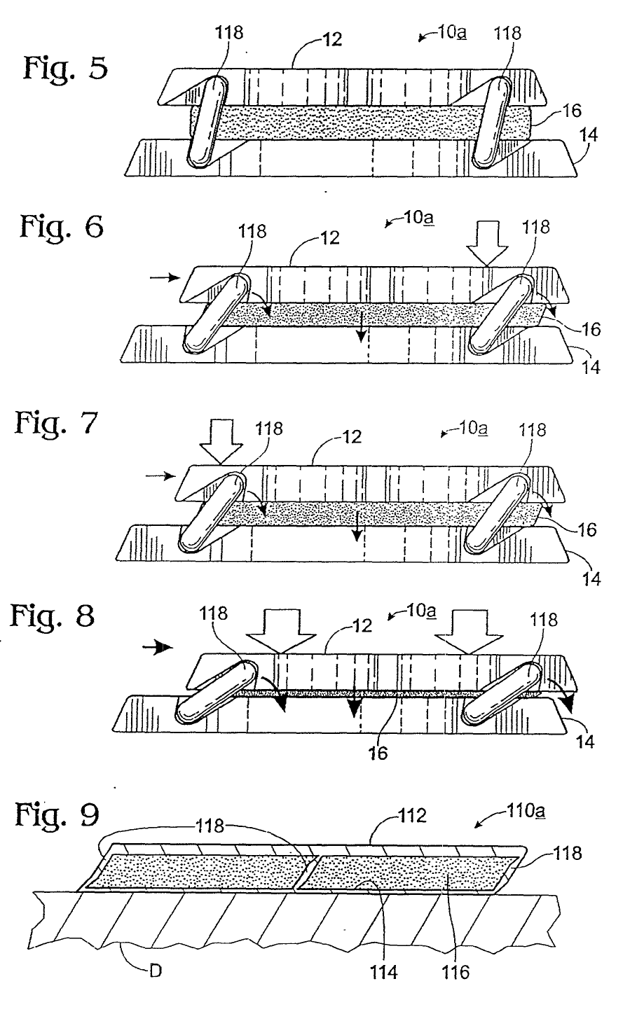

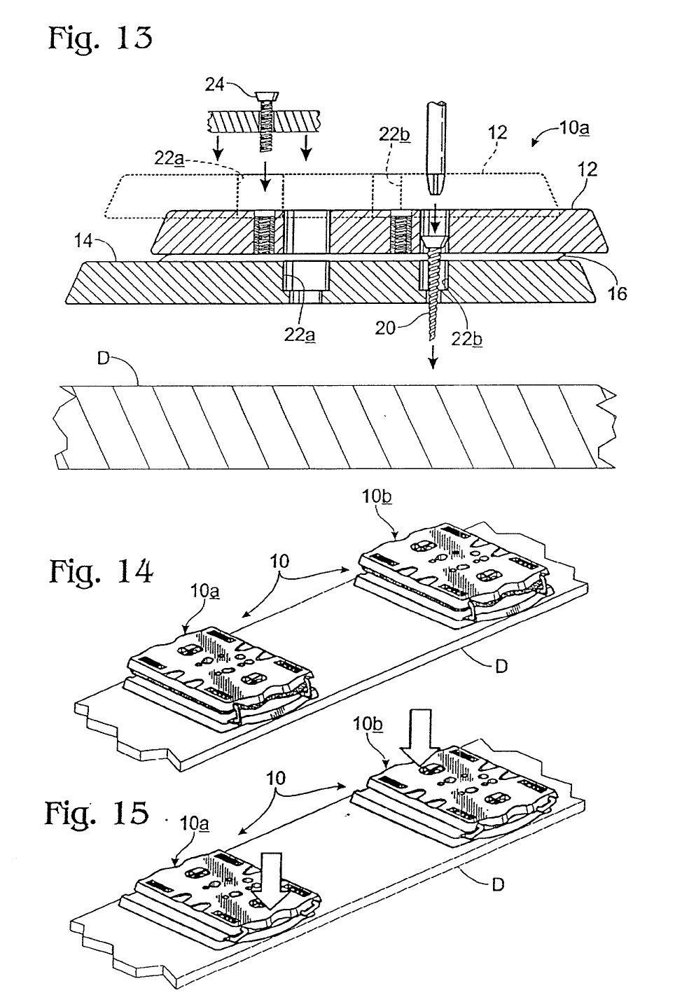

Referring to FIGS. 5-8 and 14-15, arrows are shown to illustrate that system 10 will result in the same controlled, horizontal, planar compression between plates 12 and 14 regardless of whether the snowboarder puts toe pressure (FIG. 6), heel pressure (FIG. 7), side (of boot or boots) pressure (FIG. 8), or toe-and-heel pressure (FIG. 15) on the plates.

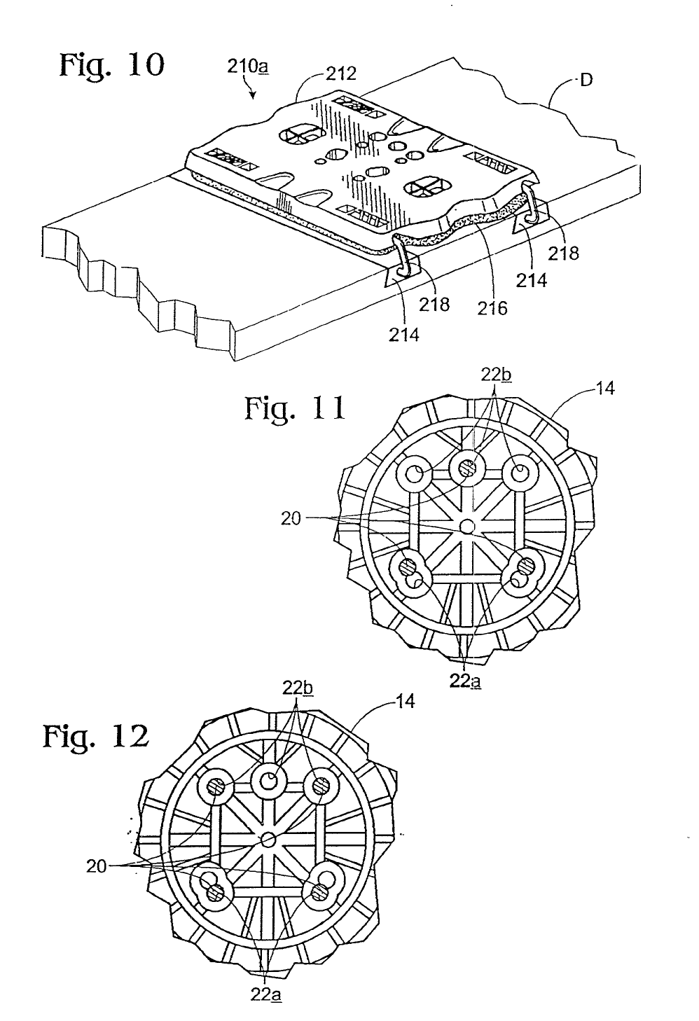

Referring to FIGS. 9-10, two alternate embodiments of the suspension system of the invention are shown. In FIG. 9, suspension element 110a is formed integrally by extruding suitable synthetic materials to form links 118 integral with plates 112 and 114 that sandwich a foam layer 116. Plate 114 is suitable attached to snowboard D, and plate 112 is suitably attached to binding C as shown and described above. In FIG. 10, plate 14 is replaced by dual elongate panels 214 that are formed of a suitable material and include openings for receiving and suitably holding corresponding ends of bales 218. Bales 218 should be positioned at an angle H as described in connection with FIG. 2.

FIGS. 11-12 show the reason for constructing plate 14 with the 5-hole pattern of holes 22a and 22b. The result is to allow for the 3-screw (FIG. 11) or 4-screw (FIG. 12) combinations which will accommodate attachment to the two types of hole patterns that snowboard manufacturers presently use when manufacturing snowboards. By constructing plate 14 as shown, there is no need for drilling additional holes in the snowboard when attaching suspension elements 10a and 10b.

Referring to FIG. 13, one can see how plate 14 can be attached to the snowboard by manually compressing plates 12 and 14. The result is to align holes 22a and 22b in plates 12 and 14 (and corresponding holes in foam layer 16) to allow screws and a screwdriver to fit therethrough for tightening screws in the desired holes.

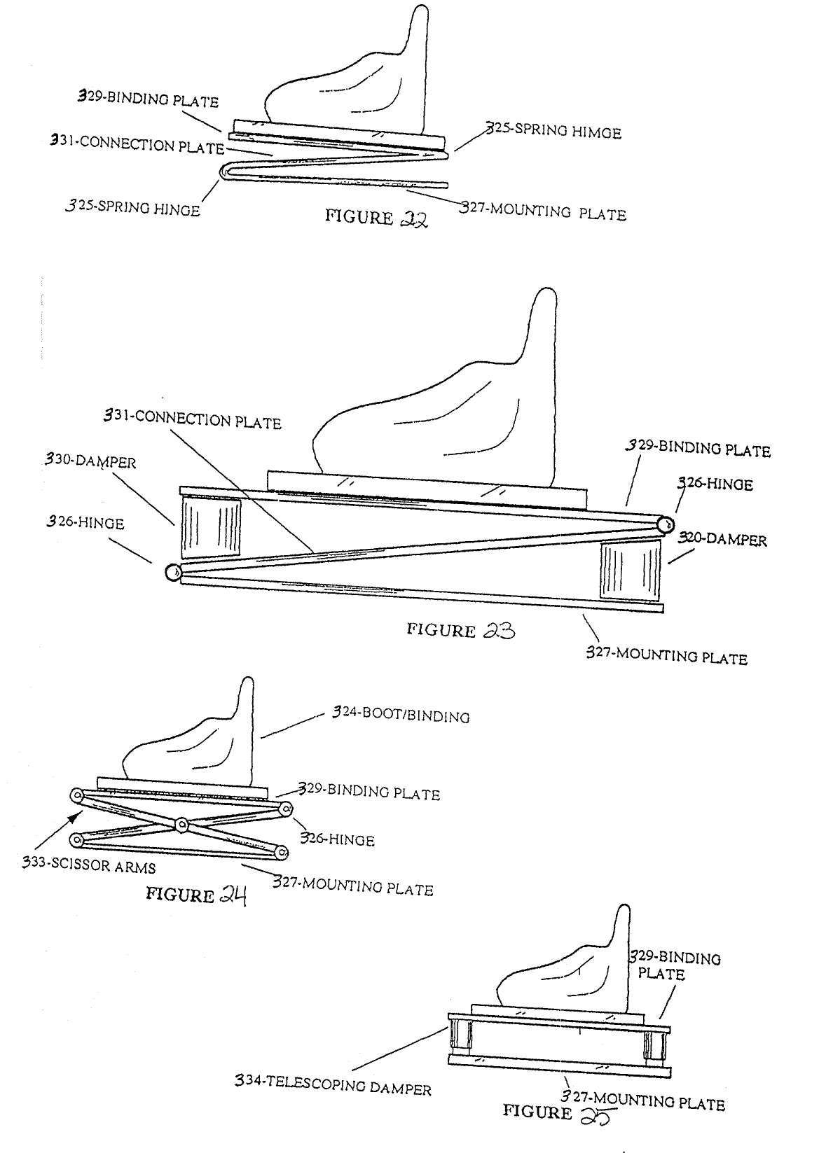

FIG. 17 shows the most elemental version of the snowboard suspension system. It is simply a piece of springy material bent to form a mounting plate 327, and binding plate 329. The fulcrum is a spring hinge 325. It may be fabricated from spring steel (preferably stainless), or some form of composite with fiber reinforcement. A bottom stop 323 may be placed anywhere between the hinge and distal end of the mounting plate 327. Another version incorporates a regular hinge 326 as the fulcrum (as in FIG. 18), and a damper 330 may be included as a replacement for the spring hinge 325. All the figures on sheet 7 deal with simple snowboard suspension systems, as opposed to the compound snowboard suspension system shown in FIGS. 22 and 23. In all cases, the snowboard suspension system is mounted between the board and the boot/binding.

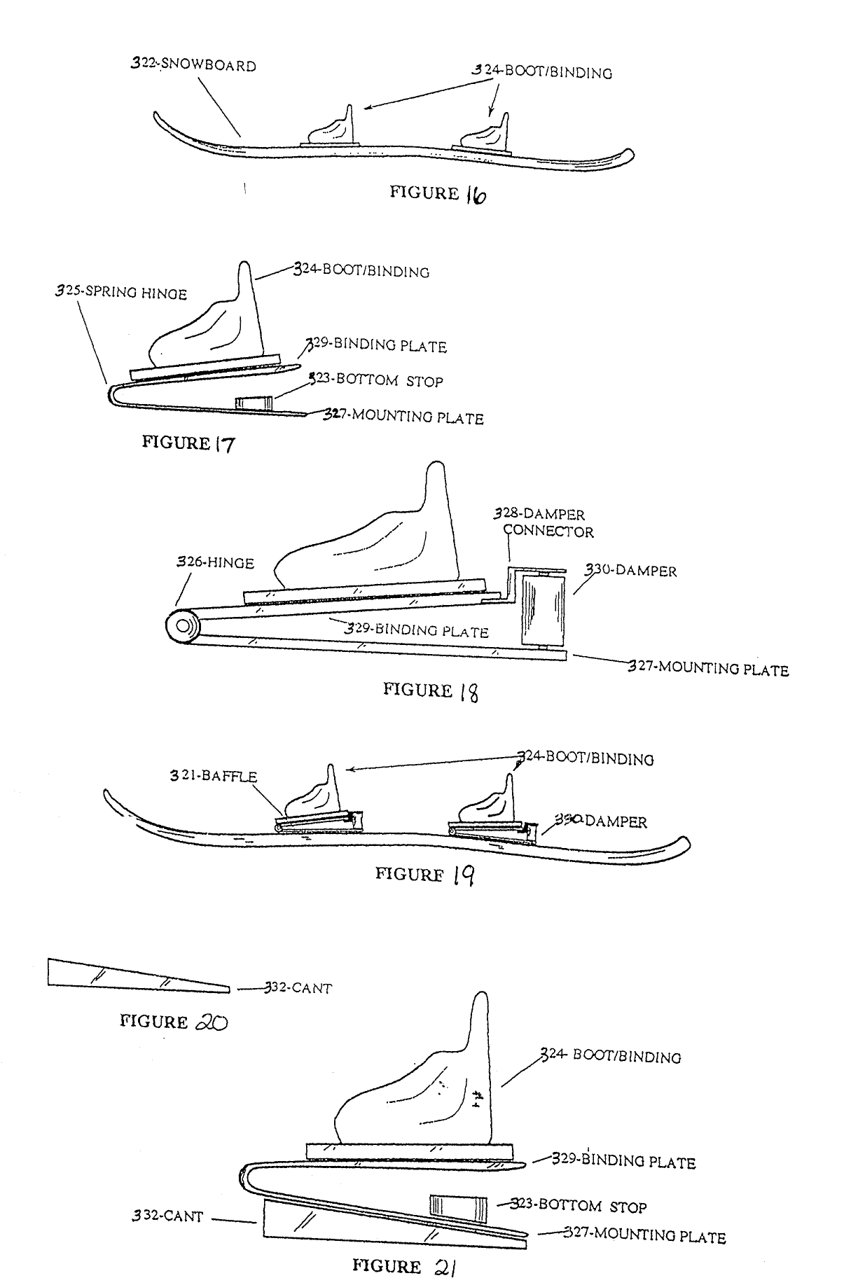

FIG. 19 demonstrates the placement of a hinge-type snowboard suspension system with dampers and baffles. Any of the other versions except for FIGS. 27 and 28 have similar placements.

The cant pictured in FIG. 20 can be made out of any water and temperature-resistant high durometer (preferably over 80) material. It may be a simple angle, or a compound angle, usually between 4 and 15 degrees, depending on the preferences of the boarder. All boot/binding 324 systems are mounted on the top of the binding plate 329.

In the hinge-type snowboard suspension system with damper pictured in FIG. 18, a damper connector 328 may be used to connect the binding plate 329 with the damper 330 in any fashion which maximizes vertical movement of the binding plate 329. The damper 330 can be a variety of things—air/oil shocks, rubber, elastomers, springs, air bladders—any combination or anything which is resilient and has rebound characteristics. Attachments of the boot/binding 324 to the binding plate 329, or the mounting plate 327 to the board 322 are achieved through the standard means—screws, slots, glues, or any other strong fastening systems. Current systems for attaching bindings to snowboards are adequate.

The compound spring-type snowboard suspension system pictured in FIG. 22 is the same material as the snowboard suspension system pictured in FIG. 17, but configured in an S curve, so as to provide vertical compression to the side of each angle. This increases the available travel and allows for a more level binding plate 329.

In the compound hinge-type snowboard suspension system in FIG. 23 the mounting plate 327 is articulated with the connection plate 331 via a hinge 326. The connection plate 331 then articulates with the binding plate 329 via another hinge 326. On one side (in this case the left), there is a damper 330 between the binding plate 329 and the connection plate 331. On the other side, there is another damper between the connection plate 331 and the mounting plate 327. These dampers are comprised of the same materials as previously described. They may also be connected to the plates (327, 329, 331) via damper connector 328 type pieces, such that maximum vertical travel is facilitated. Placement of the damper 330 so that a cantilevered configuration is achieved is also possible.

In the scissor-type snowboard suspension system pictured in FIG. 24, the mounting plate 327 is connected to two scissor arms 333 via hinges 326. They cross each other at another hinge 326, and then connect to the binding plate 329 via two more hinges 326. Horizontal movement of both ends of the scissor arms 333 is accomplished through anything which allows the hinge free horizontal movement, while limiting lateral and vertical play. There are many possible permutations of this design too broad to cover, thus the illustration and description are simplified.

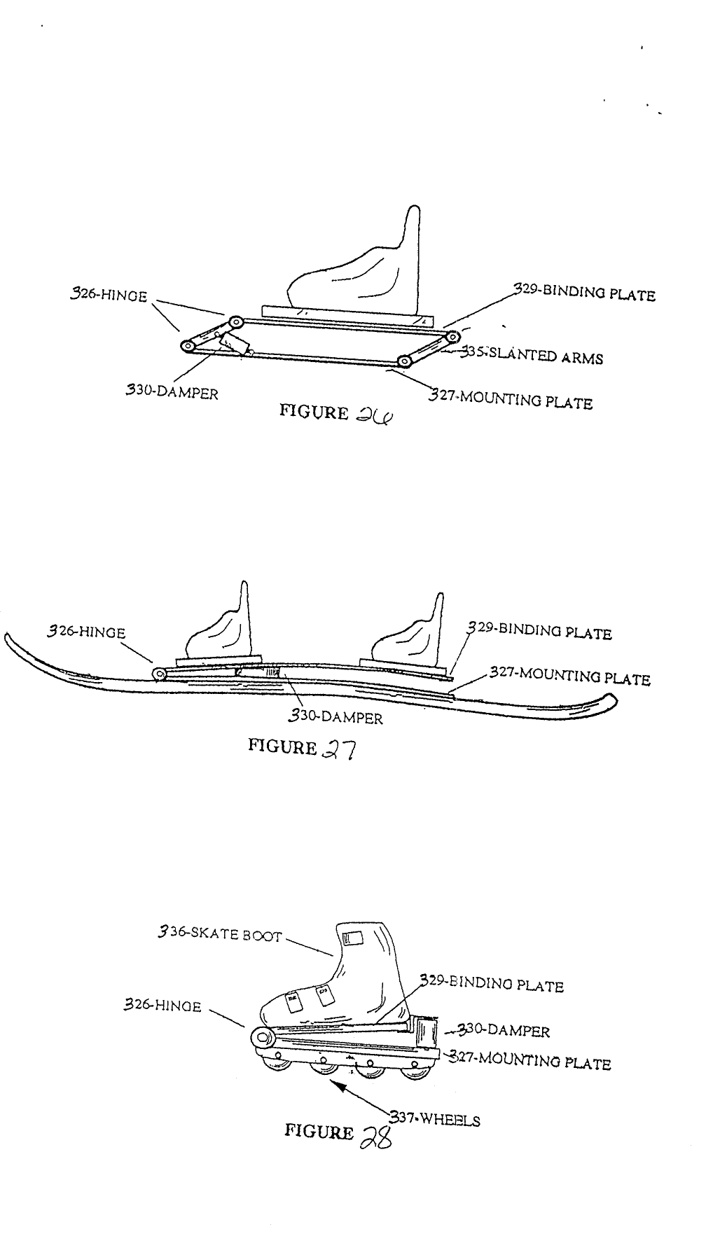

The telescoping snowboard suspension system pictured in FIG. 25 incorporates two telescoping dampers 334 between the mounting plate 327 and the binding plate 329. The attachment in both these areas is very strong, to limit any lateral play (a must for edge control), while allowing for vertical travel. Ideally, they should be very similar to the front forks on a motorcycle—a damping member which slides back and forth on a piston or plunger. As long as the telescoping members are machined to close enough tolerances (in the 0.008-0.014 range) the damping mechanism within each telescoping damper 334, can be any of the aforementioned materials—coil springs, elastomers, air/oil combination, or simply air pressure.

In the parallelogram-type snowboard suspension system pictured in FIG. 26, the mounting plate 327 articulates with the slanted arms 335 via hinges 326. The hinges 326 also serve to connect the binding plate 329 with the slanted arms 335. A damper 330 may be placed between the mounting plate 327 and the slanted arms 335, or the binding plate 329 and the slanted arms 335. Anything which allows for damping of the vertical movement of the binding plate 329 is fine. The dampers 330 may be any of the aforementioned materials.

In the cantilevered full-length snowboard suspension system pictured in FIG. 27, both boot/bindings 324 are mounted on a single binding plate 329. This articulates with the mounting plate 327 via a broad hinge 326. A damper 330 can be placed anywhere between the hinge and the mid-section of the binding plate 329 to maximize the cantilevered effect. As an alternative, the damper may also be placed towards, or beyond the end (and attached via a damper connector 328) of the binding plate 329.

With the hinge-type suspension system with damper adapted to fin in-line roller skates pictured in FIG. 28, there are several special design considerations. As the hinge must be decreased in width (to roughly the width of the wheels, compared to the width of a snowboard), it isn't as inherently strong as with the snowboard, and must therefore be of larger diameter. Also, the binding plate 329 arid mounting plate 327 must be thicker in order to counter the lateral thrust which is applied from the skater's stride. A piston-type air/oil damper 330 is the best choice for shock absorption and rebound. The shaft of the piston allows for increased lateral control and stability. More spring and less dampening are desirable qualities of the damper 330, as it's important not to absorb, but enhance the lateral thrust from the skater's stride. Top and bottom attachments of the damper 330 must be of sufficient strength to minimize lateral play during the stride.

### Operation

The central concept of the various versions of the snowboard suspension system is to allow for vertical travel of the boot/binding 324, while limiting any horizontal movement or rotation. This gives the boarder the advantage of having bumps dampened, while still allowing for maximum edge control. All the versions illustrated address this dynamic, with varying degrees of shock absorption and damping.

In each of the designs illustrated on page one, the binding plate 329 moves radially in relation to the hinge (325,326), decreasing the distance to the mounting plate 327, thus absorbing shocks that would normally be felt by the boarder. A bottom stop 323 may be incorporated to prevent the binding plate 329 from bottoming out on the mounting plate 327. Also, a baffle system made of rubber or some other flexible material may be placed between the binding plate 329 and the mounting plate 327 in order to prevent the buildup of ice or snow.

The compound spring-type snowboard suspension system pictured in FIG. 22 works similarly to the first two, but adds another curve to allow for more travel.

All the snowboard suspension systems pictured in FIGS. 23-26 have the advantage of maximum travel coupled with relative constant fore-aft angle despite compression of the binding plate 329. Of these, the hinged compound snowboard suspension system with dampers (pictured in FIG. 23) is the most simple, and is thus the preferred embodiment. Any vertical forces are dampened by the angle of the connection plate 331 becoming more acute from the dampers 330 compressing, thus allowing the binding plate 329 to move towards the mounting plate 327.

The scissor-type snowboard suspension system pictured in FIG. 24 allows for vertical travel of the binding plate 329 by increasing the acute angle on the scissor arms 333. In the telescoping-type snowboard suspension system pictured in FIG. 25, the binding plate 329 moves in relation to the mounting plate 327 via telescoping dampers 334.

In the parallelogram-type snowboard suspension system pictured in FIG. 26, there is a great possibility of vertical travel as long as the damper(s) 330 are mounted outside of the slanted arms 335, in order to provide clearance.

In the cantilevered full-length snowboard suspension system pictured in FIG. 27, the binding plate 329 moves radially in relation to the hinge 326, decreasing the distance to the mounting plate 327. The cantilevered damper 330 allows for vertical travel. The design approximates the “feel” of a standard board, due to both bindings being mounted on the binding plate 329, instead of moving independently. This is neither an advantage or disadvantage, simply another choice for those who prefer it. In order for this to work optimally, the mounting plate 327 must extend to the area below where the rear bindings 324 are mounted. The mounting plate must also be of a semi-flexible material, in order to allow for free flexion of the board.

In each version the boot/binding 324 is always mounted on the binding plate 329, and the snowboard suspension system is secured to the snowboard 322 via the mounting plate 327. This allows for after-market fitting of snowboard suspension systems, in addition to fitting right from the factory. As previously mentioned, either “soft” or “plate” bindings may be used.

Use of these snowboard suspension systems is very simple. The boarder simply attaches the boot/bindings 324, and proceeds as they would on a standard board without snowboard suspension system, exuberant with the enhanced “feel” of the board.

The suspension system for in-line roller skates pictured in FIG. 28 is well-suited for inclusion in production skates. However, there are some possibilities for aftermarket products. Anything which allows for a flex-free connection between the bottom of the boot 324, and the binding plate 329 is fine. One possibility is to offer a system wherein the hinge 330 and mounting plate 327 are an integral unit, and can be changed on a given skateboot by removing them at the hinge 330, and replacing them with a similar assembly that offers different performance features.

### Conclusion, Ramifications, and Scope of Invention

There are many possibilities for further elaborations of these basic designs. In terms of materials usage, the most desirable combinations would be those that offer lightweight and strength. Any of the carbon fiber reinforced composites, or alloys would fit the bill. Whatever material is used should be resistant to temperature extremes, UV radiation, corrosion, chipping, breaking, or other forms of breakdown. All fittings should be stainless tell, or some other corrosion-resistant material. The actual snowboard suspension system may be mounted with the fulcrum or hinge 326 mounted towards the front or back. This is largely dependent on fore-aft angular considerations of the broader. A baffle 321 system may be incorporated in order to keep snow entirely out of the area of compression. A variety of dampers 330 may be used, ranging from simple air bladders to sophisticated air/oil shocks and torsion bars. A configuration which allows for progressive damping by combining various dampers 330 is the most desirable. The “feel” of the snowboard suspension system will be determined by the relative springiness and travel of each configuration. Every snowboard suspension system could be custom-tailored to the individual boarder by adjusting vertical travel, springiness, damping, sideways deflection, and placement of the snowboard suspension system on the board. These factors would be influenced by the boarder's skill, weight, interests (e.g. freestyle or racing), and preferred terrain.

The hinged and hinged-compound type snowboard suspension system (as in FIGS. 18 and 23) are the most flexible in terms of allowing for the aforementioned customized configurations. As such, they are the preferred embodiments. By adjusting the placement of the dampers 330 relative to the hinges 326), first through third class levers can be incorporated. In addition, by varying the durometer of each damper 330, progressive rebound and damping can be attained. Different durometer dampers 330 may be used on front and back, depending on the conditions. A cantilever-style configuration is the most desirable in terms of maximizing the amount of travel in relation to compression of the damper 330. For the current use, compression-type dampers 328 would be preferred over elongation-type dampers. Any other design considerations would be dictated by cost, available materials, and desired performance features.

These types of suspension systems can also be adapted to fit downhill skiis. The only real difference is a greater emphasis on controlling fore-aft flexion, which has been done with the designs pictured in FIGS. 23-26. Not only do these systems allow for increased shock absorption, but, as with snowboards, they alter the “feel” of the skin in rather interesting ways.

The hinge-type snowboard suspension system with damper adapted to fit in-line skates (as pictured in FIG. 28) is a significant improvement over current fixed systems insofar as it dampens shocks and significantly enhances the feel of the skates due to the rebound effect and energy return. Alterations may be in the form of the other designs described herein. The fulcrum, or hinge 326 may be placed further back, and a damper positioned in front, as well as behind it. A lock-out mechanism could be incorporated which keeps the suspension system from working, should that be desirable. Various damper 330 combinations could be offered for different weights and abilities.

Accordingly, the reader will see that the various designs for a snowboard suspension system covered by this application have the following advantages over current board/binding configurations:

They provide a way to quickly customize the feel of the board.

They minimize the possibility of injury from rough terrain.

They provide a means for the boarder to move forward on level terrain without undoing the bindings, by “bouncing” the board back and forth−similar to what skateboarders do.

They create an entirely new dynamic for the snowboarder—a more lively “feel,” and enhanced turning capability.

They provide a simple and effective means of absorbing shock from bumpy terrain for snow boarders, skiers, and skaters alike.

They increase the possibilities in “freestyle” boarding, due to the springier dynamic and adjustability.

They allow for a greater range of weight distribution and transference of weight during a turn.

they make the sport more appealing to older people, whose bodies aren't as resilient as they once were.

Although the description above contains many specificities, these should not be construed as limiting the scope of this invention, but as merely providing some illustrations of some of the presently preferred embodiments of this invention. The basic concept of a binding plate 329 which moves vertically in relation to a mounting plate 327 and has a means for damping or enhancing this movement is the central feature of these designs. To my knowledge, there are no precedents in the prior art which these designs emulate. Thus the scope of these designs should be determined by the appended claims and their legal equivalents, rather than by the examples given.

I claim:

1. A snowboard suspension system comprising:
a binding plate with securing means for attaching a binding, a mounting plate with securing means for attachment to a snowboard, and a means for coupling said binding plate to said mounting plate which allows for relatively free substantially vertical movement of said binding, whereby said snowboard suspension system mitigates bumpy terrain and lessons the possibility of injury, while still allowing for optimal control.

2. The snowboard suspension system of claim 1 wherein said binding plate is coupled to said mounting plate by way of a spring hinge.

3. The snowboard suspension system of claim 1 wherein said binding plate is coupled to said mounting plate by way of a hinge, and a damping means affects movement between said binding plate and said mounting plates.

4. The snowboard suspension system of claim 1 wherein a canting means is placed between said snowboard and said binding, whereby the angle of said binding plate may be adjusted.

5. The snowboard suspension system of claim 1 wherein said binding plate is coupled to said mounting plate by way of a plurality of spring hinges and a plurality of connection plates.

6. The snowboard suspension system of claim 1 wherein said binding plate is connected to said mounting plate by way of a plurality of hinges and a plurality of connection plates, and a plurality of damping means affect vertical movement of said binding plate.

7. The snowboard suspension system of claim 1 wherein said binding plate is coupled to said mounting plate by way of a plurality of scissor arms.

8. The snowboard suspension system of claim 7 wherein a plurality of damping means are coupled to said scissor arms, affecting movement between said binding plate and said mounting plate.

9. The snowboard suspension system of claim 1 wherein said binding plate is coupled to said mounting plate by way of a plurality of telescoping means which allow for substantially vertical travel of said mounting plate.

10. The snowboard suspension system of claim 9 wherein a plurality of damping means are coupled to said telescoping means, affecting vertical movements of said binding plate.

11. The snowboard suspension system of claim 1 wherein said binding plate is coupled to said mounting plate by way of a plurality of slanted arms which allow for substantially vertical movement of said mounting plate.

12. The snowboard suspension system of claim 11 wherein a plurality of damping means are coupled to said slanted arms, affecting movement of said mounting plate.

13. The snowboard suspension system of claim 1 which incorporates a baffle means for preventing the accumulation of snow and ice, attached underneath said binding plate.

14. The snowboard suspension system of claim 1 which includes a bottom stop means for prevention of contact between said mounting plate said binding plate.

15. The snowboard suspension system of claim 1 wherein said snowboard suspension system is adjusted to fit a pair of downhill skiis by attaching each of said mounting plates to a ski instead of a snowboard.

16. The snowboard suspension system of claim 1 wherein said snowboard suspension system is adapted to fit a pair of in-line roller skates, wherein instead of the binding plate having securing means for attachment to a binding, there are securing means for attachment to a skate boot, and instead of the mounting plate having securing means for attachment to a snowboard, there are securing means for attachment to a series of wheels, thereby allowing for substantially vertical travel of said wheels, while minimizing lateral deflection.

17. The snowboard suspension system of claim 16 consisting of said mounting plate and hinge assembly, further including a coupling means for attachment to a skate boot.

18. The system of claim 1 wherein the binding members and the mounting members take the form of plates.

19. A snowboard suspension system for use with a snowboard that includes an elongate, flexible snow-planing member and dual elongate bindings for receiving a user's boots, with the long axis of the bindings being located at an angle relative to the long axis of the snow-planing member, the snowboard suspension system comprising:
dual suspension elements, each being coupled to a corresponding one of the dual bindings, each suspension element having a top surface, a bottom surface and a desired thickness, and being formed to compress a preselected amount when a suitable force is applied to either the top or bottom surface; and
joining means for coupling each suspension element to the snow-planing member so that both suspension elements are linked by the snowboard.

20. The system of claim 19 wherein the dual suspension elements each include a binding member with a long axis and securing means for attaching to a corresponding binding, and wherein the joining means takes the form of dual mounting members each with corresponding long axes and securing means for attaching to the snow-planing member so that the long axis of each mounting plate is at an angle relative to the long axis of the snow-planing member.

21. A snowboard suspension system for use with a snowboard that includes an elongate, flexible snow-planing member and dual elongate bindings for receiving a user's boots, with the long axis of the bindings being located at an angle relative to the long axis of the snow-planing member, the snowboard suspension system comprising:
dual suspension elements, each being coupled to a corresponding one of the dual bindings, each suspension element having a top expanse, a bottom expanse and a middle region formed to compress upon application of a force and expand upon relaxation of the force, with compression and expansion of the middle region allowing for relative, bi-directional movement between the top expanse and bottom expanse, and each suspension element being constructed so that application of a downward force at any location on the top expanse will cause the entire top expanse to move toward the bottom expanse; and
joining means for coupling each suspension element to the snow-planing member so that both suspension elements are linked by the snowboard.
